(19) United States
(12) Patent Application Publication
(10) Pub. No.: US 2008/0217026 A1
(43) Pub. Date: Sep. 11, 2008

(54) Composition for fighting fire, device for use therewith and methods of making and using

(75) Inventor: Francis X. Hursey, West Hartford, CT (US)

Correspondence Address: MICHAUD-DUFFY GROUP LLP, 306 INDUSTRIAL PARK ROAD, SUITE 206, MIDDLETOWN, CT, 06457, US

(73) Assignee: On Site Gas Systems, Inc., Newington, CT (US)

(21) Appl. No.: 11/716,463

(22) Filed: Mar. 9, 2007

(51) Int. Cl. A62C 5/02

(52) U.S. Cl. 169/15

(57) ABSTRACT

A fire-fighting foam is made by cooling a liquid concentrate, combining the cooled liquid concentrate composition with an expansion gas, and allowing the combined liquid concentrate and expansion gas to expand. A diffuser for dispensing a fire-extinguishing product has a discharge line having an interior, a discharge line intake and a diffuser outlet. There is a casing around a portion of the discharge line, the casing enclosing a space around said portion of the discharge line. The casing has an inlet and an outlet, and the discharge line has an aspirator inside the casing. A fire-fighting foam can be made by flowing a liquid concentrate through the diffuser via the diffuser intake, flowing an expansion gas into the inlet, and dispersing the liquid-gas composition via the diffuser outlet to yield a fire-fighting foam.

### CROSS-REFERENCE TO RELATED APPLICATION

This application claims the benefit of U.S. provisional application No. 60/780,548, filed Mar. 8, 2006, which is hereby incorporated herein by reference, in its entirety.

### TECHNICAL FIELD

This invention relates generally to compositions useful for fighting fires and methods for making and using such compositions. More particularly, the invention relates to fire-fighting foams and to apparatuses for dispensing fire-fighting foams.

### BACKGROUND

Fire-fighting foams are known for fighting fires, including coal mine fires. For example, U.S. Pat. No. 6,988,558 to Araki, et al., dated Jan. 24, 2006, discloses such foams and is incorporated herein by reference, in its entirety. Prior art fire-fighting foams are produced by adding an expansion gas to a liquid concentrate. The liquid concentrate typically comprises a nonflammable base liquid that often has a surfactant therein. A thickening agent is sometimes included in the liquid concentrate to increase the viscosity of the fire-fighting foam, thereby facilitating the retention of the fire-fighting foam when sprayed on burning fuel. Unfortunately, the expansion gas added to the liquid concentrate is air, which contains about 20% oxygen on a molar basis. Thus, the fire-fighting foam contains a component that feeds the fire it is intended to suppress or extinguish. In addition, some thickening agents contain available oxygen, which also supports fires. In the case of some coal mine fires, the available oxygen in the fire-fighting foam helps the fire continue for extended periods of time (e.g., years) before becoming extinguished.

Based on the foregoing, it is the general object of this invention to provide a fire-fighting foam that overcomes the drawbacks of prior art fire-fighting foams.

### SUMMARY OF THE INVENTION

The present invention resides in one aspect in a method for making a fire-fighting foam. The method comprises cooling a liquid concentrate, combining the cooled liquid concentrate composition with an expansion gas, and allowing the combined liquid concentrate and expansion gas to expand.

The present invention resides in another aspect in a diffuser for dispensing a fire-extinguishing product, comprises a discharge line having an interior, a discharge line intake and a diffuser outlet; and a casing around a portion of the discharge line, the casing enclosing a space around said portion of the discharge line. The casing comprises a casing inlet and a casing outlet, and the discharge line comprises an aspirator inside the casing to permit fluid flow between the interior of the discharge line and the space enclosed by the casing.

The present invention resides in another aspect in an optional alternative method of making a fire-fighting foam. The alternative method comprises flowing a liquid concentrate through the diffuser via the diffuser intake, flowing an expansion gas into the inlet to combine the liquid concentrate with an expansion gas to produce a liquid-gas composition, and dispersing the liquid-gas composition via the diffuser outlet to yield a fire-fighting foam.

A method of delivering a fire-extinguishing product using the diffuser described herein comprises flowing a feed composition into the intake of the device and dispensing from the diffuser outlet a fire-extinguishing product that contains the feed composition.

A method of suppressing a fire, comprising making a fire-fighting foam by the method described herein and dispensing the foam onto the fire.

### BRIEF DESCRIPTION OF THE DRAWINGS

FIG. 1 is a schematic, partly broken elevation view of a diffuser apparatus for discharging fire-extinguishing products;

FIG. 2 is an exploded view of the aspirator of FIG. 1.

FIG. 3 is a schematic elevation view of the diffuser of FIG. 1 in combination with a diffuser nozzle.

### DETAILED DESCRIPTION OF THE PREFERRED EMBODIMENTS

A fire-fighting foam is made from a liquid concentrate into which an expansion gas is mixed. In accordance with one aspect of this invention, the expansion gas is an inert gas that is substantially free of oxygen. The liquid concentrate comprises a nonflammable base liquid and, optionally, additives thereto such as a surfactant, thickener, etc. One suitable inert expansion gas is nitrogen; other suitable gases will be apparent to one of ordinary skill in the art. The liquid concentrate is cooled before the expansion gas is added thereto. Although in the specifically disclosed embodiments the nonflammable base liquid is water and the inert extractant gas is nitrogen, the foam is not so limited in this regard and other non-flammable liquids and inert gases are within the scope of the invention.

Preferably, the thickening agent (if any) present in the fire-fighting foam contains little or no available oxygen, so that the thickening agent does not contribute available oxygen to the fire-suppressing compositions.

The fire-fighting foam may be a high-expansion foam, i.e., a foam that is expandable to several times the volume of the initial starting material. A typical high-expansion foam is prepared from a concentrate that comprises a surfactant solubilized in a non-flammable solvent. One type of foam concentrate usable with the present invention is “High-expansion Concentrate, Type 2.0 AE35,” which is manufactured by the National Mine Service Company of North Indiana, Pa. Wetting agents may also be included in the concentrate to facilitate the penetration of the fuel. The foam may be proportioned (i.e., mixed with the fire-suppressing composition) in any ratio that results in a suitable mixture for fire-fighting purposes.

The fire-fighting foam may be applied directly onto a fire to extinguish the flames by smothering the fuel being oxidized and/or lowering the temperature of the fuel below its flash point. To smother the flames, the fire-fighting foam is used to isolate the fuel from contact with the ambient atmosphere, which contains oxygen. The fire-fighting foam may be dispersed to the burning fuel by using any suitable spray technique on the foam or on a fluid combination of the liquid concentrate and expansion gas that forms the foam, e.g., pressure spraying, sprinkling, or misting, e.g., by generating a fog that is directed over the fuel.

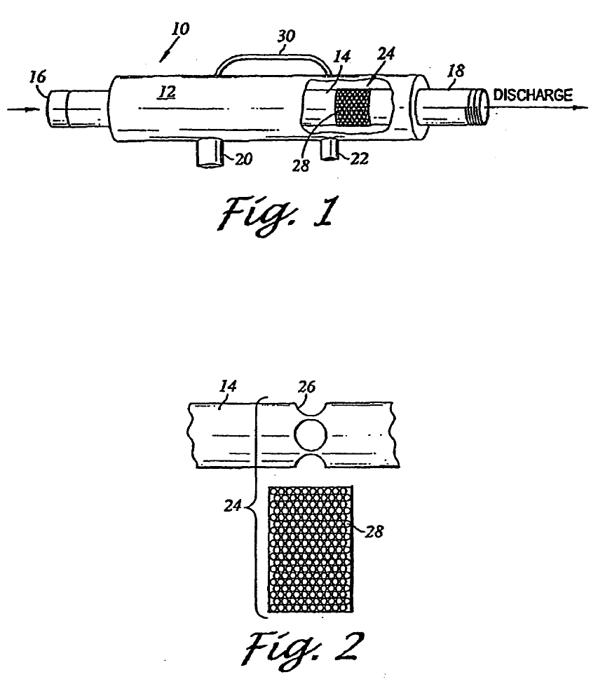

Referring now to FIG. 1, one type of apparatus through which a fire-extinguishing product can be dispersed is shown generally at 10 and is hereinafter referred to as “diffuser 10.” Diffuser 10 comprises a cylindrical outer casing 12 through the interior of which extends a discharge line 14 parallel with an axis of the outer casing. The ends of the outer casing 12 are closed around a portion of the discharge line 14. One end of the discharge line 14 extends beyond the outer casing 12 to define an intake 16 that communicates with a source of a diffuser feed composition. The opposite end of the discharge line 14 extends beyond the outer casing to define a diffuser outlet 18 for dispensing the fire-extinguishing product. The discharge line has an interior passage through which a fluid may flow from the intake 16 (a first diffuser intake) to the diffuser outlet 18. The casing 12 defines an enclosed space around the exterior of the portion of the discharge line that is disposed in the casing. In the illustrated embodiment, the casing 12 includes an optional inlet 20 (i.e., a second diffuser intake) and an optional outlet 22 (i.e., a drain or second diffuser outlet). The portion of the discharge line 14 inside the casing defines an aspirator 24 for entraining, from the space in the casing around the discharge line, an additive into the fluid flowing through discharge line 14. Referring to FIG. 2, an aspirator portion of the diffuser 10 includes aspirator 24 defined by a plurality of openings 26 in the wall of the discharge line. Each of the openings 26 is spaced apart from the adjacent openings such that the openings are substantially equilaterally spaced around the discharge line. Although only four openings 26 are shown, it is within the scope of the present invention to have fewer or more openings. A metal screen 28 is disposed about the discharge line 12 to overlie the openings 26. For ease of handling the diffuser 10, a handle 30 is provided.

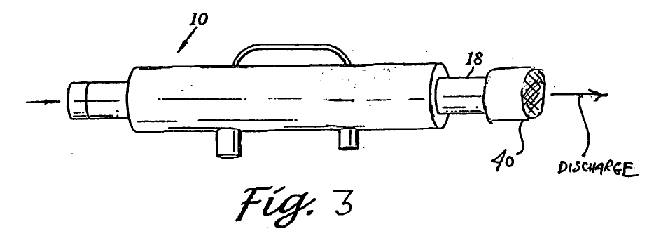

Referring now to FIG. 3, a diffuser nozzle 40 can be affixed to the end of the diffuser outlet 18 by any suitable means such as by the provision of external threads on the end of the diffuser outlet that threadably engage corresponding internal threads in the diffuser nozzle. The diffuser nozzle serves to enhance the expansion of a foam discharged from the diffuser 10.

The diffuser 10 may be used in a variety of ways. In one embodiment, a fire-extinguishing product can be discharged via the diffuser 10, without adding anything to the feed composition via the diffuser 10.

Alternatively, the diffuser 10 can be used as a mixer to combine components of a fire-extinguishing product to be delivered from the diffuser outlet 18. Generally, a first component is provided via the intake 16 and a second component is provided via inlet 20. The first component and the second component intermix via the aspirator 24. In a specific embodiment, the diffuser 10 is used to prepare and disperse a fire-fighting foam. A liquid concentrate is provided as a feed composition via intake 16, and the expansion gas is added thereto as a second component, via inlet 20. The fluid combination of the liquid concentrate and expansion gas is then discharged via outlet 18 and is allowed to expand into a foam. Optionally, the liquid concentrate is cooled to a temperature below ambient temperature before it is provided to intake 16. The expansion gas (e.g., nitrogen) allows the mixture of the liquid concentrate and the expansion gas to expand into a foam as the mixture leaves the diffuser outlet 18. Excess liquid concentrate and nitrogen may be drained from the interior of the outer casing 12 through the drain outlet 22.

In other alternative embodiments, diffuser 10 can be used to add nitrogen gas (e.g., as a second component) to other types of fire-suppressing feed compositions for other fire-extinguishing products to be dispersed at outlet 18.

In yet another alternative embodiment, diffuser 10 can be used to proportion the liquid concentrate and expansion gas, or any other separate components of a fire-extinguishing product that are provided via the intake 16 and the inlet 20. Optionally, the proportioning may be effected by venturi-type devices or line-proportioning devices, both of which may also be applicable in portable equipment set-ups.

In a preferred embodiment, one method of extinguishing a fire (e.g., in a confined and/or poorly ventilated area, such as a mine) generally comprises the step of spraying or otherwise depositing the fire-extinguishing product onto the flaming fuel. In another embodiment, a method of extinguishing a fire comprises the steps of combining separate components of a fire-extinguishing product to create a flowing stream of the product, and spraying or otherwise depositing the product onto the flaming fuel.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the disclosure.

What is claimed is:

1. A method for making a fire-fighting foam, comprising cooling a liquid concentrate, combining the cooled liquid concentrate composition with an expansion gas, and allowing the combined liquid concentrate and expansion gas to expand.

2. The method of claim 1, wherein the expansion gas comprises nitrogen.

3. The method of claim 1, wherein the concentrate comprises a base liquid that comprises water, and wherein the method comprises making the concentrate by cooling the water before adding the expansion gas.

4. A fire-fighting foam made by the method of claim 1.

5. The foam of claim 4, wherein the expansion gas comprises nitrogen.

6. A diffuser for dispensing a fire-extinguishing product, comprising:
a discharge line having an interior, a discharge line intake and a diffuser outlet; and
a casing around a portion of the discharge line, the casing enclosing a space around said portion of the discharge line;
wherein the casing comprises a casing inlet and a casing outlet; and
wherein the discharge line comprises an aspirator inside the casing to permit fluid flow between the interior of the discharge line and the space enclosed by the casing.

7. The diffuser of claim 6, wherein the aspirator comprises an aperture in the discharge line, the aperture allowing fluid flow between the interior of the casing and the interior of the discharge line, and a screen over the aperture.

8. The diffuser of claim 6, wherein the diffuser outlet comprises a diffuser nozzle.

9. A method of making a fire-fighting foam, comprising
flowing a liquid concentrate through the diffuser of claim 6 via the diffuser intake,
flowing an expansion gas into the inlet to combine the liquid concentrate with an expansion gas to produce a liquid-gas composition; and
dispersing the liquid-gas composition via the diffuser outlet to yield a fire-fighting foam.

10. The method of claim 9, wherein the expansion gas comprises nitrogen.

11. The method of claim 9, comprising cooling the liquid concentrate.

12. The method of claim 11, wherein the liquid concentrate comprises water.

13. A method of delivering a fire-extinguishing product using the diffuser of claim 1 comprises flowing a feed composition into the intake of the device and dispensing from the diffuser outlet a fire-extinguishing product that contains the feed composition.

14. The method of claim 13, wherein the feed composition comprises a first component of the fire-extinguishing product, the method further comprising flowing a second component of the fire-extinguishing product into the casing inlet; and
combining the first component with the second component to produce the fire-extinguishing product.

15. A method of suppressing a fire, comprising making a fire-fighting foam by the method of claim 1 and dispensing the foam onto the fire.

16. The method of claim 15, wherein the fire is a coal mine fire.
